(19) United States
(12) Patent Application Publication
(10) Pub. No.: US 2025/0138784 A1
(43) Pub. Date: May 1, 2025

(54) MATRIX CALCULATION BLOCK AND COMPUTER-IMPLEMENTED METHOD FOR COMPUTER-AIDED GENERATION OF AN EXECUTABLE CONTROL PROGRAM

(71) Applicant: dSPACE GmbH, Paderborn (DE)

(72) Inventors: Alina Girod, Paderborn (DE); Joerg Niere, Paderborn (DE); Michael Mair, Paderborn (DE)

(21) Appl. No.: 18/495,784

(22) Filed: Oct. 27, 2023

(51) Int. Cl. G06F 7/57; G06F 7/499

(52) U.S. Cl. CPC G06F 7/57; G06F 7/4991; G06F 7/49926

(57) ABSTRACT

A matrix calculation block for a graphical modeling environment that executes block diagrams. Blocks of the block diagram have input ports and/or output ports, and are connectable through the respective ports by signal lines for data transmission. The matrix calculation block includes: at least one input port configured to receive an input matrix signal; a calculation definition having at least one error condition check; at least one output port configured for emitting an output signal, the output signal being a vector signal or a matrix signal; and an error port configured for emitting an error signal. A value of the error signal indicates an error state of a plurality of predefined error states, which includes an error-free state. The value of the error signal depends on whether the at least one error condition check is fulfilled or not.

### FIELD

Embodiments of the present invention relate to a matrix calculation block for a graphical modeling environment for technical systems and the generation of executable code from a block diagram for programming control devices.

### BACKGROUND

Control devices, often called electronic control units, are used in a large number of applications in order to capture physical variables of a process and/or to act on a process by means of connected actuators; for example, an anti-lock control of a braking process. The time constants determining the dynamic behavior of the process frequently require cycle times of 1 ms or shorter, so that a real-time capability of the electronic control unit (ECU) is generally needed. For cost reasons, ECUs often have microcontrollers with low memory and limited computing power, for which reason the size and efficiency of the executable code is important.

In order to accelerate the design of control devices, control strategies are often developed on the basis of models in a computing environment such as MATLAB/Simulink. The process and/or controller or, in general, the behavior of the ECU may thus be simulated first, and the presence of desired properties may be checked. In particular, the models may be block diagrams that contain blocks that perform operations, such as calculations, wherein a block can calculate an output signal from multiple input signals, for example. As a rule, block diagrams are executed cyclically, wherein all blocks are kept permanently in memory, and each block is executed once per time step. In particular, a block may apply one or more operations to at least one input signal from the last step in order to generate at least one output signal of the current step. From the models, source code for programming the control device can be generated directly by means of a code generator. For example, a code generator for generating production quality source code is known from the document entitled “Production Quality Code Generation from Simulink Block Diagrams,” Proceedings of the 1999 International Symposium on Computer Aided Control System Design, Kohala Coast, Hawaii, by H. Hanselmann et al. In this case, the production code generated can be adapted by an additional annotation of the blocks or block variables.

Many control algorithms use matrix calculations to determine output signals. Common matrix calculations include matrix inversions or the solution of a linear system of equations; a particular example is the Kalman filter, which is used in many applications, such as controls with (time) varying parameters. The Kalman filter is also needed for most ADAS/AD applications, such as lane change assist. Providing an efficient implementation for these common matrix calculations would allow for facilitating the development of ECUs for automotive applications.

### SUMMARY

Embodiments of the present invention provide a matrix calculation block for a graphical modeling environment that executes block diagrams. Blocks of the block diagram have input ports and/or output ports, and are connectable through the respective ports by signal lines for data transmission. The matrix calculation block includes: at least one input port configured to receive an input matrix signal; a calculation definition having at least one error condition check; at least one output port configured for emitting an output signal, the output signal being a vector signal or a matrix signal; and an error port configured for emitting an error signal. A value of the error signal indicates an error state of a plurality of predefined error states, which includes an error-free state. The value of the error signal depends on whether the at least one error condition check is fulfilled or not.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

The present invention will become more fully understood from the detailed description given hereinbelow and the accompanying drawings which are given by way of illustration only, and thus, are not limitative of the present invention, and wherein:

FIG. 1 shows an exemplary diagram of a computer system according to some embodiments;

FIG. 2 shows an exemplary diagram of software components in a computer system according to some embodiments;

FIG. 3a shows a first block diagram with a matrix calculation block for solving a system of linear equations specified in a non-square matrix, according to some embodiments;

FIG. 3b shows a subsystem of the first block diagram with a matrix calculation block, according to some embodiments;

FIG. 4a shows a second block diagram with a matrix calculation block for solving a system of linear equations specified in a square matrix, according to some embodiments;

FIG. 4b shows a subsystem of the second block diagram with a matrix calculation block, according to some embodiments; and

FIG. 5 shows a flowchart illustrating a computer-implemented method for computer-aided generation of an executable control program, according to some embodiments.

### DETAILED DESCRIPTION

In an embodiment, a matrix calculation block for a graphical modeling environment for technical systems is provided. The modeling environment is adapted to execute block diagrams, wherein the blocks of the block diagram have input ports and/or output ports, and wherein the blocks are connectable through their ports by signal lines for data transmission. The matrix calculation block includes at least one input port for receiving an input matrix signal, a calculation definition comprising at least one error condition check, at least one output port for emitting an output signal, wherein the output signal is a vector signal or a matrix signal, and an error port for emitting an error signal, wherein a value of the error signal indicates an error state of a plurality of predefined error states comprising an error-free state, wherein the value of the error signal depends on the at least one error condition check being fulfilled or not.

Further scope of applicability of the embodiments of the present invention will become apparent from the detailed description given hereinafter. However, it should be understood that the detailed description and specific examples, while indicating exemplary embodiments of the invention, are given by way of illustration only, since various changes and modifications within the spirit and scope of the invention will become apparent to those skilled in the art from this detailed description.

Embodiments of the invention provide for matrix calculation blocks with an improved error handling. Checking for the error condition may be performed before, during or after performing the calculation specified in the calculation definition. In other words, the input matrix signal may be checked, occurrence of an error condition during the calculation may be checked and/or the output signal or elements of the output matrix or vector may be checked to determine whether the error condition is fulfilled or not. The calculation definition may specify a matrix calculation such as a matrix decomposition or the multiplication of a matrix by a vector; calculations may be performed in floating point data types such as double. Because the matrix calculation blocks include an error port for emitting an error signal, wherein a value of the error signal indicates an error state of a plurality of predefined error states comprising an error-free state, subsequent blocks can simply compare the error signal to predefined values in order to determine whether an error has occurred. There is no need to access each element of the output signal for checking whether the output matrix or vector can be used in subsequent calculations. As the value of the error signal indicates an error state of predefined error states, the correct handling of the particular error can easily be implemented.

In an embodiment, the error signal is of an integer data type or an enumeration data type. Preferably, a value of zero (or a predefined value ERR_OK) indicates that no error has occurred. Thus, comparing the value of the error signal with zero (or the predefined value ERR_OK) allows for a simple determination whether an error occurred at all. For instance, the error signal may assume one of the values given in the following table:

| Identifier | Value | Error |
|---|---|---|
| ERR_OK | 0 | Valid output |
| ERR_SINGULAR | 1 | Input matrix is singular |
| ERR_NON_SYMMETRIC | 2 | Input matrix is not symmetric |
| ERR_NON_POSITIVE_DEFINITE | 3 | Input matrix is not positive definite |
| ERR_INCONSISTENT | 4 | System of linear equations specified by |
| | | input matrices is inconsistent |
| ERR_UNDERDETERMINED | 5 | System of linear equations specified by |
| | | input matrices is underdetermined |
| ERR_OVERFLOW | 6 | At least one calculation resulted in a |
| | | value outside the interval of possible |
| | | values for the data type |

In an embodiment, the matrix calculation block allows for choosing one of a plurality of calculation definitions. This allows for easily changing the calculation without having to modify the block diagram any further.

In an embodiment, a calculation definition includes code in a scripting language of the modeling environment and/or a call specification for a function in a source code library. When the calculation definition includes code in a scripting language, the matrix calculation block can easily be used in a model-in-the-loop simulation that involves executing the block diagrams without full-scale code generation. When the calculation definition includes a call specification for a function in a source code library, sophisticated numerical algorithms can be provided in predefined library files. The function to be called may depend on the chosen data type for the input and/or output signals. The source code can be compiled for the desired target platform, so that no platform-specific implementations are needed.

In an embodiment, the matrix calculation block allows for choosing a precision of the calculation and/or a data type used for calculations, in particular half, single or double precision floating point numbers. Choosing the data type may be performed directly in the matrix calculation block or indirectly via the data type of the input signals and/output signals or the data type of their elements. When a first data type is chosen for calculations, a second data type, preferably of lower bit width and/or precision, may be chosen for the output signal. Choosing a precision may involve a change in calculation method; for instance, a desired precision may be used as end condition for an implicit matrix calculation method. If the desired precision is not reached within a predefined time limit, a switch to a direct calculation method may be performed.

In an embodiment, the error condition check determines one or more of:
at least one property of the input matrix signal and/or at least one property of the output signal, wherein an error signal is emitted when the at least one property is not present or outside of a predefined acceptance interval;
eigenvectors and/or eigenvalues of the input matrix signal, wherein preferably an error signal is emitted when at least one eigenvalue is outside of a predefined acceptance interval;
whether an overflow or a division by zero occurred in a calculation.

For a matrix signal, properties of the matrix can be determined. This may involve checking whether the elements of the matrix have a value in a predefined acceptance interval. For a triangular matrix, elements that are not part of the desired upper or lower triangle need to have a value of zero. Other properties of the input matrix or the output matrix may also be determined, such as whether the matrix is symmetric. By determining eigenvectors and/or eigenvalues of a matrix signal, it can e.g. be ascertained whether the matrix is positive definite. These error condition checks allow to determine whether properties of the input matrices needed for a specific calculation method are fulfilled. If they are not fulfilled, the error signal can be set to a specific value indicating the missing property.

In an embodiment, the calculation definition specifies a decomposition of the matrix received via the input port, in particular a Cholesky decomposition, a Gauss decomposition or a Householder decomposition, wherein the error condition includes one or more of a check for an overflow or a division by zero occurring in a calculation, a check for the eigenvalues of the matrix being in a predefined value range, or a check for a property of the matrix, such as symmetry.

In an embodiment, the calculation definition specifies the solution of a system of linear equations, wherein the error condition includes an inconsistency of the system of linear equations.

Embodiments of the present invention further relate to a computer-implemented method for generating source code from a block diagram in a graphical modeling environment for technical systems, wherein the blocks of the block diagram have input ports and/or output ports, wherein the blocks are connectable through their ports by signal lines for data transmission, wherein the block diagram describes a functionality of a technical system, the block diagram comprising at least one matrix calculation block according to embodiments of the invention, the method comprising reading the block diagram in a model editor of the graphical modeling environment, translating the matrix calculation block into a preprocessor macro and/or a function call, wherein the preprocessor macro or function call refers to a predefined function for performing the matrix calculation specified by the calculation definition. Preferably, the predefined function is selected based on a data type of the input matrix signal or a data type of elements of the input matrix signal. This allows for choosing the best implementation for a specific data type.

Embodiments of the present invention further relate to a method for configuring a control unit, wherein the control unit includes at least one arithmetic logic unit and preferably at least one sensor and/or at least one actuator in order to record data on a physical process and/or influence said process, the method includes the steps of:
a. generating a source code using the method according to embodiments of the invention;
b. compiling the source code for the at least one arithmetic logic unit such that an executable code is generated;
c. transmitting the executable code to the control unit; and
d. storing the executable code on a non-volatile memory of the control unit and/or executing the executable code by the at least one arithmetic logic unit of the control unit.

Embodiments of the present invention further relate to a non-transitory computer-readable medium containing instructions that, when executed by a processor of a computer system, cause the computer system to carry out a method according to the embodiments of the invention.

Embodiments of the present invention further relate to a computer system, including a processor, a random-access memory, a graphics controller connected to a display, a serial interface connected to at least one human interface device, and a nonvolatile memory, in particular a hard disk or solid state disk, the nonvolatile memory comprising instructions that, when executed by the processor, cause the computer system to carry out a method according to embodiments of the invention.

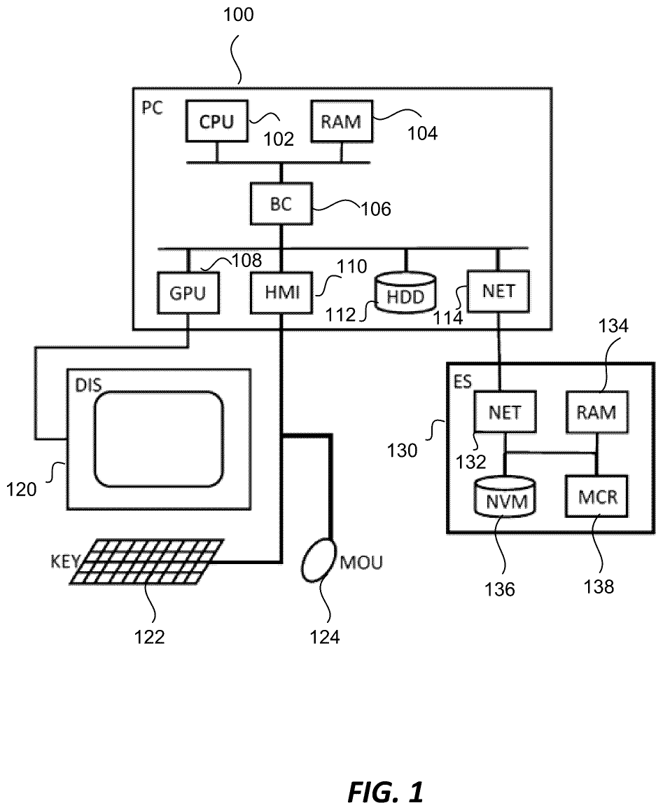

FIG. 1 shows an example configuration of a computer system PC 100. The computer system has a processor CPU 102, which may in particular be implemented as a multi-core processor, a main memory RAM 104, and a bus controller BC 106. The computer system PC 100 is preferably configured to be manually operated directly by a user, a monitor DIS 120 being connected via a graphics card GPU 108, and a keyboard KEY 122 and a mouse MOU 124 being connected via a peripheral interface HMI 110. In principle, the human-machine interface of the computer system PC 100 could also be configured as a touch interface. The computer system 100 further includes a non-volatile data store HDD 112, which may in particular be configured as a hard disk and/or solid-state disk, as well as an interface NET 114, in particular a network interface. A control unit ES 130 may be connected via the interface NET 114. In principle, one or more interfaces of any type, in particular wired interfaces, may be provided on the computer system PC 100 and may each be used for connecting to a control unit ES 130. Expediently, a network interface in accordance with the Ethernet standard may be used; the interface NET 114 may also be wireless, in particular configured as a WLAN interface or in accordance with a standard such as Bluetooth.

The control unit ES 130 may be configured as a series control unit or as an evaluation board for a target platform. Expediently, it includes an interface NET 132 for connecting a microcontroller MCR 138, having a different architecture from the processor of the computer system, and a main memory RAM 134 and a non-volatile memory NVM 136 to the computer system PC 100. Where the control unit ES 130 is present, a processor-in-the-loop simulation of the generated code may preferably take place.

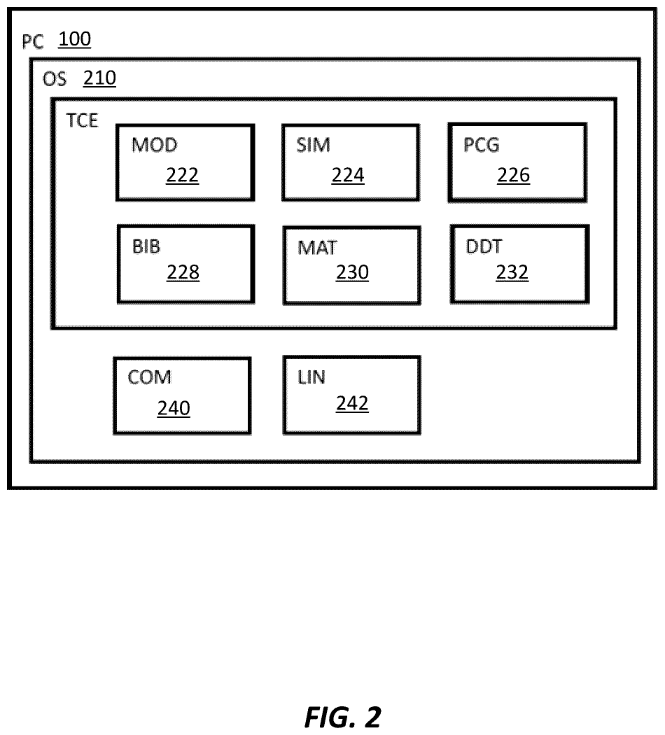

FIG. 2 shows a diagram of the software components that are preferably installed on the computer system PC 100. These software components use mechanisms of the operating system OS 210 to, for example, access the non-volatile memory HDD 112 or to establish a connection to an external computer via the network interface NET 114.

A technical computing environment TCE 220 allows models to be created and source code to be generated from the models. In a modeling environment MOD 222, models of a dynamic system may be created, preferably via a graphical user interface. In particular, these may be block diagrams including a plurality of blocks and describing the behavior over time and/or internal states of a dynamic system. At least some of the blocks are linked via signals, i.e., directional links for exchanging data, which may be scalar or composite. Blocks may be atomic, i.e., may, from the perspective of the surrounding blocks, form a unit in which all the input signals have to be applied at the start of a computing step and all the output signals have to be present at the end of a computing step. If block diagrams are hierarchical, a multiplicity of blocks in a subordinate plane may describe the construction of a block in a superordinate plane. Hierarchical or composite blocks may include a multiplicity of blocks in a subordinate plane, even if said blocks are atomic. In particular, composite blocks may be sub-systems; sub-systems may have additional properties, such as implementation in a separate function and/or triggering of the execution of the sub-system via a dedicated signal. Special blocks may be arranged in sub-systems to further specify the properties of the sub-system.

The computing environment TCE 220 includes one or more libraries BIB 228 from which blocks or modules for building a model may be selected. In a script environment MAT 230, instructions may be input interactively or via a batch file in order to perform calculations or modify the model. The computing environment TCE 220 further includes a simulation environment SIM 224 that is configured to interpret or execute the block diagram in order to examine the behavior of the system over time. These calculations are preferably carried out using high-precision floating-point numbers on one or more cores of the microprocessor CPU of the computer system.

Preferably, a source code may be generated in a programming language such as C from a created model using a code generator PCG 226. Additional information on the model, in particular on the block variables, is expediently stored in a definition data pool DDT 232. Expediently, value ranges and/or scales are allocated to the block variables to assist with the calculation of the model using fixed-point instructions. Desired properties of the source code, for example conformity with a standard such as MISRA, may also be set or stored in the definition data pool DDT 232. Expediently, each block variable is allocated to a predetermined variable type, and one or more desired properties are set, for example the allowability of optimizations such as merging variables. The code generator PCG 226 preferably analyzes the settings of the definition data pool DDT 232 and takes them into account when generating the source code. The definition data pool DDT 232 may have a tree structure or be stored as a simple file in a memory of the computer system; alternatively, the definition data may be stored in a dedicated database system. The definition data pool may have a program interface and/or import/export functions.

The computer system PC 100 has a compiler COM 240 and a linker LIN 242, which expediently are configured to generate binary files that can be executed on a control unit ES 130 and/or the computer system PC 100. In principle, a multiplicity of compilers may be provided, in particular cross-compilers for different target platforms in order to support control units or evaluation boards ES 130 having different processor architectures.

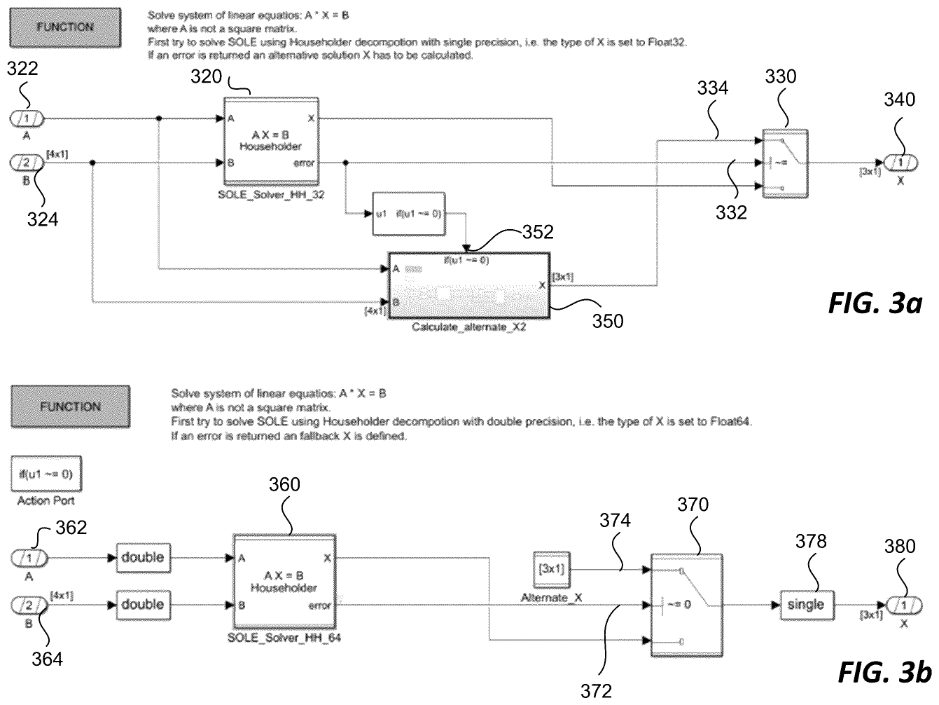

FIG. 3a displays a first block diagram with a matrix calculation block 320 for solving a system of linear equations specified in a non-square matrix. This block diagram represents a function subsystem that receives input signals via input ports and emits output signals via output ports. The block diagram includes a first input port A 322 and a second input port B 324 that receive matrix input signals A and B; in the example shown, the second input matrix B 324 corresponds to a column vector. The matrix input signals are forwarded to a matrix calculation block 320 SOLE_Solver_HH_32 that solves a system of linear equations A·X=B, where A is a non-square matrix, i.e. a rectangular matrix with differing sizes of the dimensions. The matrix calculation block 320 emits an output signal that contains the matrix X which is supposed to solve the system of linear equations and an error signal that indicates whether an error occurred; the solution is found using the Householder decomposition of the input matrix A, wherein the calculations are performed with single precision. Accordingly, the data type of the output signal X is of single precision, such as Float32. The matrix X solves the system of linear equations only when no error such as an overflow or a division by zero occurred in the calculations. Thus, the error signal needs to be checked for the absence of errors, in particular a value of zero, before using the output signal in any further calculations. In case of an error a predefined output signal may be emitted, such as a zero matrix or vector.

The output signal is forwarded to a switch block 330 that chooses the output signal of multiple input signals based on a selector port 332; the selector port 332 receives the error signal. When no error occurred, i.e. the error signal is 0, the switch block 330 forwards the output signal of the matrix calculation block 320 SOLE_Solver_HH_32 to an output port X 340. When the error signal indicates the presence of an error, a subsystem 350 Calculate_alternate_X2 with an alternative calculation is triggered; the output signal of the subsystem 350 is forwarded to a second input port 334 of the switch block 330. When the error signal is bigger than zero, the output signal of the subsystem 350 is forwarded to the output port X 340. Depending on the value of the error signal, different actions may be performed. For instance, if the error signal indicates that the system of linear equations is inconsistent, so that no solution exists, the further calculation described below may be omitted.

FIG. 3b shows the subsystem 350 Calculate_alternate_X2 of the first block diagram with a matrix calculation block. The subsystem 350 is a function subsystem, so that a function will be generated in the production code based on this subsystem, and it is triggered via an action port 352. When the signal input to the action port 352 differs from zero, the subsystem 350 is triggered so that it performs the calculation specified by the blocks inside the subsystem 350. The subsystem 350 includes a first input port A 362 and a second input port B 364 that receive matrix input signals A and B; in the example shown, the second input matrix B corresponds to a column vector. The matrix input signals are forwarded to a matrix calculation block 360 SOLE_Solver_HH_64 that solves a system of linear equations A·X=B, where A is a non-square matrix, i.e. a rectangular matrix with differing sizes of the dimensions. The matrix calculation block 360 emits an output signal that contains the matrix X which is supposed to solve the system of linear equations and an error signal that indicates whether an error occurred; the solution is found using the Householder decomposition of the input matrix A, wherein the calculations are performed with double precision. In principle, the calculations may be performed with any data type supported by the target platform. Because the Householder decomposition is performed with double precision, rounding errors are less pronounced and overflow errors are less likely to occur than in calculations with single precision; however, the calculations may take considerably longer. The matrix X solves the system of linear equations only when no error such as an overflow or a division by zero occurred in the calculations. Thus, the error signal needs to be checked for the absence of errors, in particular a value of zero, before using the output signal in any further calculations. In case of an error a predefined output signal may be emitted, such as a zero matrix or vector.

The output signal X of the matrix calculation block 360 SOLE_Solver_HH_64 is forwarded to a switch block 370 whose selector input 372 is connected to the error signal of the matrix calculation block 360. A second input port 374 of the switch block 370 receives a constant signal Alternate_X. When no error occurred, the output signal is forwarded to an output port X 380 that emits the signal to the block diagram of FIG. 3a. Because the output signal of the block diagram is of single precision data type, a casting block 378 for converting double precision to single precision is inserted before the output port 380 of the subsystem 350. When an error occurred in the matrix calculation block 360 SOLE_Solver_HH_64, the constant signal Alternate_X is forwarded to the output port 380 of the subsystem 350. The signal Alternate_X may e.g. only contain elements with a value of zero.

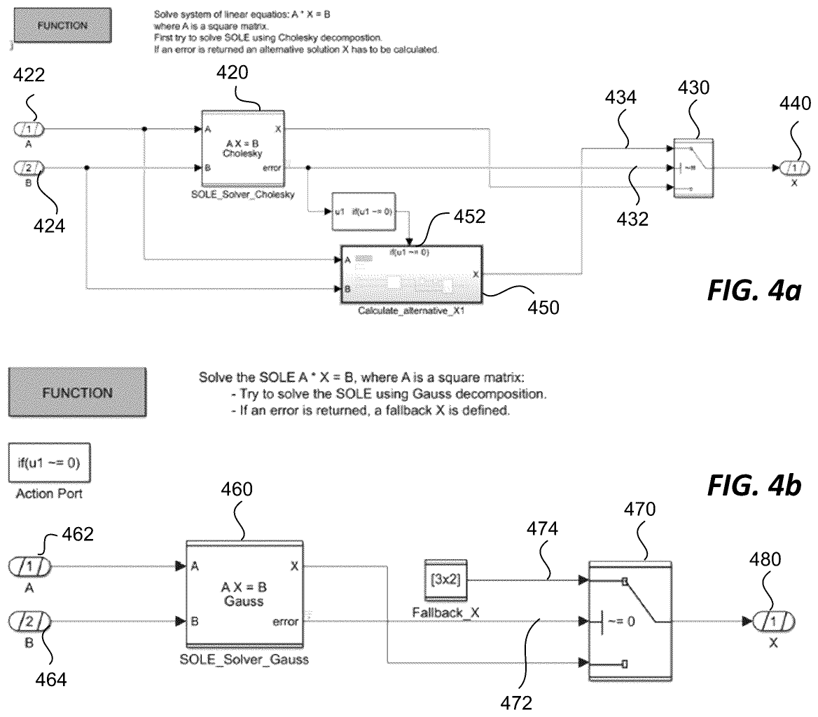

FIG. 4a displays a second block diagram with a matrix calculation block for solving a system of linear equations specified in a square matrix. This block diagram represents a function subsystem that receives input signals via input ports and emits output signals via output ports. The block diagram includes a first input port A 422 and a second input port B 424 that receive matrix input signals A and B; when the matrix B includes multiple columns, this corresponds to solving multiple systems of linear equations at once. The matrix input signals are forwarded to a matrix calculation block 420 SOLE_Solver_Cholesky that solves a system of linear equations A·X=B, where A is a square matrix, using the Cholesky decomposition. The Cholesky decomposition is only applicable when the input matrix A is symmetric and positive definite, so that these properties of the input matrix need to be checked in corresponding error condition checks. When it is applicable, it allows for finding an accurate solution fast. The matrix calculation block 420 emits an output signal that contains the matrix X which is supposed to solve the system of linear equations and an error signal that indicates whether an error occurred. The data type used for the calculation may be chosen on the data type of the output signal and/or the data type of at least one input signal. For instance, single precision floating point numbers may be chosen. The matrix X solves the system of linear equations only when the input matrix has the required symmetry properties and no error such as an overflow or a division by zero occurred in the calculations. Thus, the error signal needs to be checked for the absence of errors before using the output signal in any further calculations. In case of an error a predefined output signal may be emitted, such as a zero matrix or vector.

The output signal is forwarded to a switch block 430 that chooses the output signal of multiple input signals based on a selector port 432; the selector port 432 receives the error signal. When no error occurred, i.e. the error signal is 0, the switch block 430 forwards the output signal of the matrix calculation block 420 SOLE_Solver_Cholesky to an output port X 440. When the error signal indicates the presence of an error, a subsystem 450 Calculate_alternative_X1 is triggered; the output signal of the subsystem 450 is forwarded to a second input port 434 of the switch block. When the error signal is bigger than zero, the output signal of the subsystem 450 is forwarded to the output port X 440.

FIG. 4b is a subsystem 450 of the second block diagram with a matrix calculation block. The subsystem 450 is a function subsystem, so that a function will be generated in the production code based on this subsystem, and it is triggered via an action port 452. When the signal input to the action port 452 differs from zero, the subsystem 450 is triggered so that it performs the calculation specified by the blocks inside the subsystem 450. The subsystem 450 includes a first input port A 462 and a second input port B 464 that receive matrix input signals A and B. The matrix input signals are forwarded to a matrix calculation block 460 SOLE_Solver_Gauss that solves a system of linear equations A·X=B, where A is a square matrix. The matrix calculation block 460 emits an output signal that contains the matrix X which is supposed to solve the system of linear equations and an error signal that indicates whether an error occurred; the solution is found using the Gaussian decomposition method. The matrix X solves the system of linear equations only when the input matrix is square and no error such as an overflow or a division by zero occurred in the calculations. Thus, the error signal needs to be checked for the absence of errors before using the output signal in any further calculations. In case of an error a predefined output signal may be emitted, such as a zero matrix or vector.

The output signal X of the matrix calculation block 460 SOLE_Solver_Gauss is forwarded to a switch block 470 whose selector input 472 is connected to the error signal of the matrix calculation block 460. A second input port 474 of the switch block 470 receives a constant signal Fallback_X. When no error occurred, the output signal is forwarded to an output port X 480 that emits the signal to the block diagram of FIG. 4a. When an error occurred in the matrix calculation block 460 SOLE_Solver_Gauss, the constant signal Fallback_X is forwarded to the output port 480 of the subsystem 450. The signal Fallback_X may e.g. only contain elements with a value of zero.

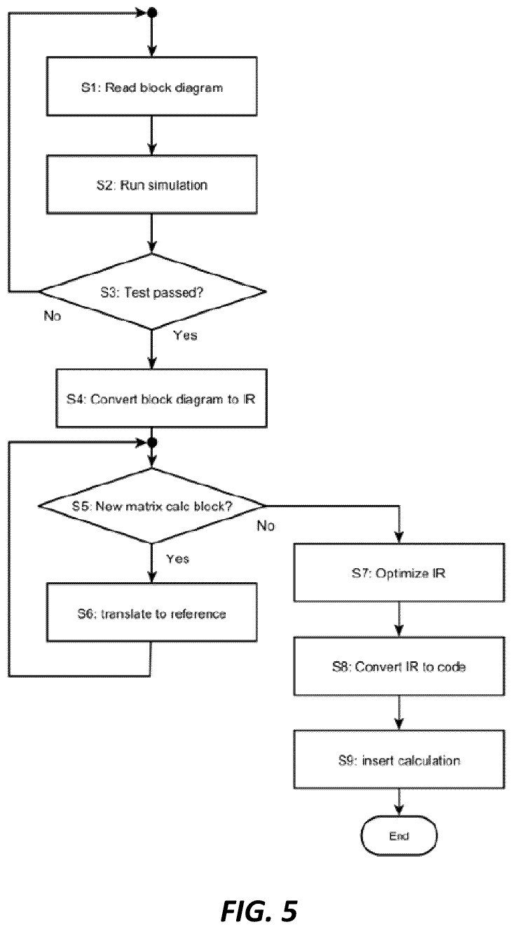

FIG. 5 displays a schematic representation of a computer-implemented method according to embodiments of the invention for computer-aided generation of an executable control program. The steps of the method are preferably carried out by one or more processors of the computer system PC.

In step S1 (Read block diagram), the processor reads in a block diagram. Expediently, reading in the block diagram also includes reading out at least one block property and/or relevant settings for generating the code, for example the data type of a variable, from the definition data pool DDT. One or more parameters of the block diagram may also be determined based on commands in the scripting environment MAT.

In step S2 (Run simulation), the processor executes the block diagram in the simulation environment SIM. The simulation may be performed using predefined stimuli as input data.

In step S3 (Test passed?), the processor compares the signals logged during simulation to predefined signal values and/or determines whether predefined pass conditions are met in order to determine whether the algorithm modeled in the block diagram has the desired properties. When this is the case (Yes), execution proceeds in step S4 to generate production code. When the pass conditions were not fulfilled (No), the block diagram needs to be modified. Execution continues in step S1 by reading in a new block diagram.

In step S4 (Convert block diagram to IR), the block diagram is converted to an intermediate representation. The intermediate representation preferably includes one or more hierarchical graphs. These can in particular be data flow graphs, control flow graphs, or a tree structure. In addition to the block diagram, additional information from a definition data pool DDT may be taken into account when generating the intermediate representation and incorporated therein. This may also include situations in which elements are generated on the basis of information in the data definition pool DDT, or in which properties of elements or relevant settings for generating the code, for example the data type of a variable, are extracted from the definition data pool DDT.

In step S5 (New matrix calc block?), the processor determines if there is a matrix calculation block that has not yet been processed. When this is the case (Yes), execution proceeds in step S6 by processing the new matrix calculation block. When no further matrix calculation blocks need processing (No), execution proceeds in step S7.

In step S6 (translate to reference), a reference to a function for implementing the matrix calculation is inserted in the block diagram. The reference may be a preprocessor macro or a function call. Preferably, inserting the reference includes determining the precision and/or data type to be used in the matrix calculation. Depending on the desired precision, different implementations of the matrix calculation may be called. Execution continues in step S5.

In step S7 (Optimize IR) the intermediate representation is optimized to reduce the number of variables required and/or the memory consumption, for example stack occupation, and/or the number of operations or processor instructions and/or the execution time of the source code. This optimization may include a multiplicity of intermediate steps in which further intermediate representations are generated between the model/block diagram and source code/program text. In particular, in each intermediate step, a set of original hierarchical graphs may be converted into a different set of changed hierarchical graphs, with one or more optimization rules being applied. Various strategies may be applied during the optimization, such as constant folding or eliminating dead code.

In step S8 (Convert IR to code), the optimized intermediate representation or the optimized hierarchical graphs resulting from the entirety of the optimization steps carried out are translated into source code of a textual programming language, in particular C code or C++ code. In this step too, a further optimization may be carried out, in particular such that the generated instructions represent a sub-set of the instructions included in principle by the language and/or the generated control structures represent a sub-set of the control structures included in principle by the language. This makes it possible to satisfy precisely defined rules. Alternatively or additionally, additional information, for example a reference between program rows and a block of the block diagram, may be generated and incorporated into the source code in particular in the form of comments in order to improve the legibility of the source code and/or simplify debugging.

In step S9 (Insert calculation), the implementation of the matrix calculation, i.e. the predefined function to be called, is added to the source code. The implementation may be added in a separate file. Of multiple available implementations, only those implementations actually called in the generated source code may be added.

During or after code generation, information on the current block diagram or results of the code generation, for example warnings, may be stored in the definition data pool. This information may be used, for example, to influence compiling of the generated source code, or to provide meta information for other tools, for example calibration information in ASAP2 format or information for generating an intermediate layer in accordance with the AUTOSAR standard. In alternative embodiments of the invention, code in a hardware description language or a configuration of a programmable hardware component may be generated from the block diagram.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A matrix calculation block for a graphical modeling environment for technical systems, the graphical modeling environment being adapted to execute block diagrams, blocks of the block diagram having input ports and/or output ports, the blocks being connectable through the respective input ports or the respective output ports by signal lines for data transmission, the matrix calculation block comprising:
at least one input port configured to receive an input matrix signal;
a calculation definition comprising at least one error condition check;
at least one output port configured for emitting an output signal, wherein the output signal is a vector signal or a matrix signal; and
an error port configured for emitting an error signal, wherein a value of the error signal indicates an error state of a plurality of predefined error states, the plurality of predefined error states comprising an error-free state, wherein the value of the error signal depends on whether the at least one error condition check is fulfilled or not.

2. The matrix calculation block according to claim 1, wherein the error signal is of an integer data type or an enumeration data type.

3. The matrix calculation block according to claim 2, wherein the value of the error signal being zero indicates that no error has occurred.

4. The matrix calculation block according to claim 1, wherein the matrix calculation block is configured to allow choosing the calculation definition as one of a plurality of calculation definitions.

5. The matrix calculation block according to claim 1, wherein the calculation definition comprises code in a scripting language of the graphical modeling environment and/or a call specification for a function in a source code library.

6. The matrix calculation block according to claim 1, wherein the matrix calculation block is configured to allow choosing a precision of a calculation and/or a data type used for the calculation as one of half, single or double precision floating point numbers.

7. The matrix calculation block according to claim 1, wherein the error condition check determines one or more of:
at least one property of the input matrix signal and/or at least one property of the output signal, wherein the error signal is emitted when the at least one property of the input matrix signal or the at least one property of the output signal is not present or outside of a first predefined acceptance interval;
eigenvectors and/or eigenvalues of the input matrix signal, wherein the error signal is emitted when at least one eigenvalue of the eigenvalues is outside of a second predefined acceptance interval;
whether an overflow or a division by zero occurred in a calculation.

8. The matrix calculation block according to claim 1, wherein the input matrix signal comprises a matrix, wherein the calculation definition specifies a decomposition of the matrix received via the input port, the decomposition comprising a Cholesky decomposition, a Gauss decomposition or a Householder decomposition, wherein the error condition comprises one or more of a check for an overflow of at least one element of the matrix, a check for elements of the matrix being in a predefined value range, a check for a symmetry property of the matrix.

9. The matrix calculation block according to claim 1, wherein the calculation definition specifies a solution of a system of linear equations, wherein the error condition comprises an inconsistency of the system of linear equations.

10. A computer-implemented method for generating source code from a block diagram in a graphical modeling environment, blocks of the block diagram having input ports and/or output ports, the blocks being connectable through the respective input ports or the respective output ports by signal lines for data transmission, the block diagram describing a functionality of a technical system, the block diagram comprising at least one matrix calculation block according to claim 1, the method comprising:
reading the block diagram in a model editor of the graphical modeling environment, and
translating the matrix calculation block into a preprocessor macro and/or a function call, wherein the preprocessor macro or the function call refers to a predefined function for performing a matrix calculation specified by the calculation definition.

11. A method for configuring a control unit, wherein the control unit comprises at least one arithmetic logic unit and at least one sensor, and/or at least one actuator in order to record data on a physical process and/or influence the physical process, the method comprising the steps of:
generating the source code using the method according to claim 10;
compiling the source code for the at least one arithmetic logic unit to generate an executable code;
transmitting the executable code to the control unit; and
storing the executable code on a non-volatile memory of the control unit and/or executing the executable code by the at least one arithmetic logic unit of the control unit.

12. A non-transitory computer-readable medium containing instructions that, when executed by a processor of a computer system, cause the computer system to carry out the method according to claim 10.

13. A computer system, comprising a processor, a random-access memory, a graphics controller connected to a display, a serial interface connected to at least one human interface device, and a nonvolatile memory, the nonvolatile memory comprising a hard disk or a solid state disk, the nonvolatile memory comprising instructions that, when executed by the processor, cause the computer system to carry out the method according to claim 10.
